(19) United States
(12) Patent Application Publication
(10) Pub. No.: US 2006/0287425 A1
(43) Pub. Date: Dec. 21, 2006

(54) Method for production of a waterborne copolymer dispersion

(75) Inventors: Ola J. Karlsson, Lund (SE); Jan-Erik Jonsson, Lund (SE)

Correspondence Address: BUCHANAN, INGERSOLL & ROONEY PC, POST OFFICE BOX 1404, ALEXANDRIA, VA, 22313-1404, US

(73) Assignee: CELANESE EMULSIONS NORDEN AB, Perstorp (SE)

(21) Appl. No.: 10/561,843

(22) PCT Filed: Jun. 24, 2004
(86) PCT No.: PCT/SE04/01022

§ 371 Date: Jan. 13, 2006

(30) Foreign Application Priority Data
Jul. 1, 2003 (SE) 0301940-3

(51) Int. Cl. C08F 283/00

(52) U.S. Cl. 524/457

(57) ABSTRACT

Disclosed is a method for production of a waterborne copolymer dispersion wherein the yielded copolymer comprises monomer units derived from at least one polymerisable super hydrophobic monomer having a lower water solubility. The copolymer dispersion is obtained in an emulsion polymerization performed in an aqueous media and in the presence of at least one dendritic polymer.

The present invention refers to a method for production of a waterborne copolymer dispersion comprising monomer units derived from at least one polymerisable super hydrophobic monomer, such as super hydrophobic an allyl, vinyl, maleic or diene monomer. The copolymer dispersion is obtained in a polymerisation process performed in an aqueous media and in the presence of at least one dendritic polymer. In a further aspect the present invention refers to the use of said copolymer dispersion.

Emulsion polymerisation is the most important industrial method for manufacture of aqueous dispersion polymers. Emulsion polymerisation is typically performed in an aqueous medium in the presence of a surfactant and a water soluble initiator and is usually rapidly giving high molecular weight homo or copolymers at high solids content and low dispersion viscosity. The final product is normally an opaque, grey or milky-white dispersion of high molecular weight polymer(s) at a solids content of typically 30-60% in water. Said dispersion typically comprises acrylic, methacrylic and crotonic acid homo and copolymers, methacrylate and acrylate ester homo or copolymers, vinyl acetate homo or copolymers, vinyl and vinylidene chloride homo or copolymers, ethylene homo or copolymers, styrene and butadiene homo or copolymers, acrylamide homo or copolymers, butadiene-acrylonitrile copolymers, styrene-acrolein copolymers and/or where applicable carboxylated versions. Traditional applications for such aqueous dispersions are adhesives, binders for fibres and particulate matter, protective and decorative coatings, dipped goods, foam, paper coatings, backings for carpet and upholstery, modifiers for bitumens and concrete and thread and textile modifiers. More recent applications include biomedical applications as protein immobilisers, visual detectors in immunoassays, as release agents, in electronic applications as photoresists for circuit boards, in batteries, conductive paint, copy machines and as key components in molecular electronic devices.

Ethylene-vinyl ester copolymers are typically prepared in the same manner as polyethylene and other polyolefines. Ethylene-vinyl ester copolymers can be made in for instance solution, suspension or emulsion processes. Said copolymers are predominantly made by emulsion techniques. Ethylene-vinyl ester copolymer processes must of necessity be operated under high pressure, since ethylene is a gas as well as a sluggish monomer.

It is commonly known that for example hydrophobic water insoluble monomers are difficult or even impossible to copolymerise in conventional as well as pressurised emulsion polymerisations. U.S. Pat. No.5,521,266 proposes the use of cyclodextrins and derivatives thereof as complexing agents for monomers having a low water solubility and for chain transfer agents also having a low water solubility.

However, it has now quite unexpectedly been found that in the presence of dendritic (hyperbranched) polymers it is possible to incorporate super hydrophobic monomers in a copolymer yielded in a conventional or pressurised emulsion polymerisation. The mechanism is most likely a transport of the super hydrophobic monomer through the aqueous phase from the monomer droplets to the growing latex particles, whereby the dendritic polymer acts as a transport vehicle. The hydrophilic surface of the dendritic polymer facilitates the transport through the aqueous phase and the hydrophobic interior of the molecules is a good environment for the hydrophobic monomers. The process is driven by the reduction in free energy in the system by decreasing the chemical potential of the hydrophobic monomers. Since they gain free energy by being diluted from the high concentration in the monomer droplets to the lower concentration in the latex particles. The monomer is consumed in the latex particles and the process will continuously go on as long there is monomer left in the system. The successful incorporation of a hydrophobic monomer in a copolymer can be determined by measuring the volume distribution of the particle sizes obtained. Such a measurement can be performed using a laser light diffraction instrument.

The present invention accordingly refers to a method for production of a waterborne copolymer dispersion wherein yielded copolymer comprises monomer units derived from at least one polymerisable super hydrophobic allyl, vinyl, maleic or diene monomer, that is a monomer having a water solubility of less than 0.001 g/l, and monomer units derived from at least one additional polymerisable water soluble, dilutable or miscible monomer. The copolymer dispersion is obtained in an emulsion polymerisation performed in an aqueous media and in the presence of 0.05-99.5% by weight, calculated on total amount of polymerisable monomers, of at least one dendritic polymer as polymerisation aid for said super hydrophobic monomer.

Said emulsion polymerisation is in various embodiments a one or multi stage emulsion polymerisation, such as a conventional emulsion polymerisation, using for instance liquid monomer, performed at atmospheric pressure or a pressure polymerisation, using for instance at least one gaseous monomer. A pressure polymerisation is preferably performed at a pressure of 1-200 bar, such as 3-150 bar or 5-100 bar.

Said dendritic polymer is advantageously and preferably a dendritic polyester, polyether, polyesteramide or polyetheramide built up from alcohols, epoxies, oxetanes, aminoalcohols, hydroxyfunctional carboxylic acids, carboxylic acids or anhydrides, glycidyl esters and/or glycidyl ethers. It is of course understood that alcohols, epoxies, oxetanes, aminoalcohols, hydroxyfunctional carboxylic acids, carboxylic acids or anhydrides, glycidyl esters and/or glycidyl ethers include mono, di, tri and polyfunctional compounds possessing necessary amount of reactive groups, sites and/or functions to yield and/or participate in the formation of dendritic structures, including dendrimers. The dendritic polymer is built up from a monomeric or polymeric core molecule and at least one branching chain extender and may furthermore be at least partly further chain extended by addition of for instance at least one linear or branched chain extender and/or chain stopper, such as at least one alkylene oxide, at least one saturated or unsaturated aliphatic or aromatic carboxylic acid or at least one corresponding anhydride or halide, and/or at least one carboxyfunctional ester, polyester, ether and/or polyether. Said preferred dendritic polymers are substantially of the type disclosed in the published International Patent Applications WO 93/17060, WO 93/18075, WO 96/07688, WO 96/12754, WO 00/56802 and WO 01/16213 and WO 02/040572, which all are included herein as disclosure of preferred dendritic polymers. Preferred embodiments of said dendritic polymer include dendritic polyesters and polyethers having a hydroxyfunctionality, such as having six or more hydroxyl groups. The hydroxyfunctionality in such a dendritic polymer may be derived from one or more hydroxyl, hydroxyalkyl, hydroxyalkoxy, hydroxyalkoxyalkyl and/or hydroxyalkylamide groups and/or the like.

Said at least one polymerisable hydrophobic monomer is in preferred embodiments at least one C₁₁-C₂₈-alkyl, such as C₁₂-C₁₈-alkyl, acrylate, methacrylate or crotonate, for instance lauryl or stearyl acrylate or methacrylate. Further super hydrophobic monomers include for instance hydrophobic vinyl versatates. Said super hydrophobic monomer is suitably present in an amount of for instance 0.01-99% by weight of employed polymerisable monomers.

The copolymer of the present copolymer dispersion comprises at least one additional monomer other than said super hydrophobic monomer. Additional monomer or monomers is/are selected depending on for instance desired final properties, actual polymerisation conditions and intended end uses. Said copolymer may thus additionally comprise monomer units derived from a large number of polymerisable monomers. Various embodiments include additional monomer units derived from
at least one C₁-C₁₀ alkyl acrylate, methacrylate or crotonate, such as methyl acrylate, ethyl acrylate, butyl acrylate 2-ethylhexyl acrylate, methyl methacrylate, ethyl methacrylate and/or butyl methacrylate,
acrylic acid, methacrylic acid crotonic acid, isocrotonic acid, itaconic acid, maleic anhydride and/or fumaric acid,
at least one glycidyl acrylate, glycidyl methacrylate and/or allyl methacrylate,
ethylene and/or propylene,
styrene and/or divinylstyrene,
vinyl acetate, vinyl propionate, vinyl versatate and/or dibutyl maleate,
butadiene and/or isoprene,
   as well as applicable and possible combinations of said suitable monomers or groups of monomers.
acryl amide, N-methylolacrylamide, N-methylolmethacrylamide, N-(iso-butoxymethyl)-acrylamide, N-(n-butoxymethyl)acrylamide and/or imidazolidine methacrylate,
at least one di, tri or multifunctional ester of a di, tri or polyhydric alcohol and acrylic and/or methacrylic acid, such as butanediol diacrylate, dipropylene glycol diacrylate, hexanediol diacrylate, tripropylene glycol diacrylate, butanediol diaethacrylate, ethylene glycol dimethacrylat, diethylene glycol dimethacrylate, trimethylolpropane triacrylate, ethoxylated trimethylolpropane triacrylate, ethoxylated pentaerythritol diacrylate,
at least one trialkoxyvinylsilane, allcyldialkoxyvinylsilane, acryloxyalkoxysilane, acryloxy-alkylalkoxysilane, alkoxyacrylsilane, methacryloxyalkoxysilane, methacryloxyalkyl-alkoxysilane and/or alkoxymethacrylsilane,
   as well as suitable and applicable combinations of said monomers.

Yielded copolymer may optionally in various embodiments additionally comprise monomer units derived from at least one crosslinking functional monomer, such as at least one bi-functional monomer having at least one polymerisable vinyl group and at least one hydroxyalkyl group or a monomer being an ether of such a compound. Said at least one crosslinking monomer can suitably be for instance an unsaturated organic acid amide, such as acryl amide, a N-methylol derivative of an unsaturated organic acid amide, such as N-methylolacrylamide and/or N-methylolmethacrylamide, or an ether of a N-methylol derivative, such as N-(iso-butoxymethyl)acrylamide and/or N-(n-butoxymethyl)acrylamide. Further suitable crosslinking monomers include glycidyl acrylates, glycidyl methacrylates, multifunctional acrylates and multifunctional methacrylates, allylmethacrylate, alkoxyvinylsilanes, alkoxyacrylsilanes and/or alkoxymethacrylsilanes. Said at least one crosslinking monomer is typically present in an amount of for instance 0-10%, such as 0.1-10%, 0.3-8%, 0.3-6%, 0.4-2%, 0.5-2% or 1-6%, depending on for instance desired properties, crosslinking density and selected crosslinking monomer.

Multifunctional acrylates and methacrylates are to be understood as di, tri and polyesters of di, tri or polyhydric alcohols and acrylic and/or methacrylic acid and can suitably be exemplified by diacrylates and dimethacrylates, such as butanediol diacrylate, dipropylene glycol diacrylate, hexandiol diacrylate, tripropylene glycol diacrylate, butanediol dimethacrylate,ethylene glycol dimethacrylate and diethylene glycol dimethacrylate, and/or exemplified by 2-hydroxyalkyl-2-alkyl-1,3-propanediol acrylates, 2,2-dihydroxyalkyl-1,3-propanediol acrylates, 2-hydroxyalkoxy-2-alkyl-1,3-propanediol acrylates, 2,2-dihydroxy-alkoxy-1,3-propanediol acrylates, 2-hydroxyalkoxyalkyl-2-alkyl-1,3-propanediol acrylates and/or 2,2-dihydroxyalkoxyaLkyl-1,3-propanediol acrylates, such as trimethylolpropane triacrylate, ethoxylated trimethylolpropane triacrylate and ethoxylated pentaerythritol diacrylate.

Said silanes include compounds such as trialkoxyvinylsilanes, alkyldialkoxyvinylsilanes, acryloxyalkoxysilanes, acryloxyalkylalkoxysilanes, alkoxyacrylsilanes, methacryloxy-alkoxysilanes, methacryloxyalkylalkoxysilane and/or alkoxymethacrylsilanes, wherein said alkyl and/or alkoxy is for instance linear or branched having for instance 1-4 carbon atoms. Said silanes can suitably be exemplified by trimethoxyvinylsilane, triethoxyvinylsilane, triisopropoxyvinylsilane, propyldiisopropoxyvinylsilane, methoxymethacrylsilane and/or 3-methacryloxypropyltriisopropoxysilane.

Yielded copolymer may, furthermore, optionally in said embodiments additionally comprise monomer units derived from at least one stabilising functional monomer having at least one radically polymerisable group, such as a charged group selected from sulphate, sulphonate, phosphate and/or carboxylic acid, and/or at least one colloidally and/or sterically stabilising group, such as alkoxy having a chain length of 4-60 alkoxy units derived from for instance ethylene oxide. Said stabilising monomer is preferably acrylic acid, methacrylic acid and/or vinylsulphonates, such as sodium vinylsulphonate. Said stabilising monomer is suitably and preferably present in an amount of 0-5%, such as 0.01-5%, 0.05-2% or 0.5-1.5%. Embodiments of said emulsion polymerisation can furthermore comprise the presence of at least one chain transfer agent is present during polymerisation of at least one said polymerisable monomer.

Further embodiments of the copolymer dispersion according to the present invention include species comprising at least one polymerisable surfactant, such as a surfactant comprising at least one alkenyl group, and/or a conventional surfactant.

In a further aspect, the present invention refers to the use of said novel waterborne copolymer dispersion, as disclosed above, in binders for coatings, such as decorative and/or protective paints and lacquers, adhesives and glues.

Without farther elaboration, it is believed that one skilled in the art can, using the preceding description, utilise the present invention to its fullest extent. The following preferred specific embodiments are, therefore, to be construed as merely illustrative and not limitative of the remainder of the disclosure in any way whatsoever. In the following Examples 1 and 2 refer to pressurised emulsion polymerisations according to embodiments of the present invention and Examples 4-25 refer to conventional emulsion polymerisations according to embodiments of the present invention. Examples 3 and 26-28 are reference examples referring to pressurised (Example 3) and conventional (Examples 26-28) emulsion polymerisations

Tables 1 and 2 show that the amount of grit and monomer droplets are substantially reduced when a dendritic polymer is present during the copolyrnerisation of a hydrophobic monomer. There are also non-systematic differences in the RHBM amounts for different dendritic polymers and surfactant systems but compared to emulsion polymerisations of hydrophobic monomers without dendritic polymers (Reference Examples 3 and 26-28) there are large differences.

### EXAMPLE 1

0.34 pph of a colloidal stabiliser (polyvinyl alcohol), 0.02 pph of sodium metabisulphite, 0.12 pph of sodium acetate, 1.6 pph of an anionic surfactant (Ufapol TEP2N, Unger Fabrikker A. S, Fredriksstad, Norway), 4.0E-3 pph of a defoamer (Agitan® 305, Müntzing Chemie GmbH,. Germany), 0.26 pph of a stabilising functional monomer (sodium vinyl sulphonate), 6.0E-3 pph of Mohrs salt, 0.9 pph of a dendritic polyester (Boltorn® H310, Perstorp Specialty Chemicals AB, Sweden) and 48.05 pph of water were charged to a pressure reactor and the reactor was heated to a polymerisation temperature of 65° C. 1.92 pph of vinyl acetate, 0.21 pph of lauryl acrylate and 1.25 pph of ethylene were now charged together with 0.105 pph of ammonium persulphate dissolved in 1.12 pph of water. Subsequent the so called pre-reaction, 36.0 pph of vinyl acetate and 4.0 pph of iauryl acrylate were continuously fed during 5 hours. A reactor pressure of 40 bar was, when charging of vinyl acetate commenced, applied by charging the ethylene monomer to the reactor. Said pressure was maintained until 3.53 pph of ethylene was charged and the ethylene charging was then stopped. The reactor was, following the continuous charging of the monomer mixtures, kept at 65° C. for a further hour. The prepared dispersion was now allowed to cool to room temperature.

The properties of the final dispersion and the polymerisation are given in Table 1.

### EXAMPLE 2

0.34 pph of a colloidal stabiliser (polyvinyl alcohol), 0.02 pph of sodium metabisulphite, 0.12 pph of sodium acetate, 1.66 pph of an anionic surfactant (Ufapol TEP2N, Unger Fabrikker A. S, Fredriksstad, Norway), 4.0E-3 pph of a defoamer (Agitan® 305, Müntzing Chemie GmbH, Germany), 0.26 pph of a stabilising functional monomer (sodium vinyl sulphonate), 6.0E-3 pph of Mohrs salt, 0.9 pph of a dendritic polyether (Boltorn® EO3000, Perstorp Specialty Chemicals AB, Sweden) and 49.05 pph of water were charged to a pressure reactor and the reactor was heated to a polymerisation temperature of 65° C. 1.965 pph of vinyl acetate, 0.111 pph of stearyl acrylate and 1.12 pph of ethylene were now charged together with 0.107 pph of ammoniumpersulphate dissolved in 1.140 pph of water. Subsequent the so called pre-reaction, 36.8 pph of vinyl acetate and 2.1 pph of stearyl acrylate were continuously fed during 5 hours. A reactor pressure of 40 bar was, when charging of vinyl acetate commenced, applied by charging the ethylene monomer to the reactor. Said pressure was maintained until 3.75 pph of ethylene was charged and the ethylene charging was then stopped. The reactor was, following the continuous charging of the monomer mixtures, kept at 65° C. for a further hour. The prepared dispersion was now allowed to cool to room temperature.

The properties of the final dispersion and the polymerisation are given in Table 1.

### EXAMPLE 3

### Reference

0.34 pph of a colloidal stabiliser (polyvinyl alcohol), 0.02 pph of sodium metabisulphite, 0.12 pph of sodium acetate, 1.64 pph of an anionic surfactant (Ufapol TEP2N, Unger Fabrikker A. S, Fredriksstad, Norway), 4.0E-3 pph of a defoamer (Agitan® 305, Müntzing Chemie GmbH, Germany), 0.26 pph of a stabilising functional monomer (sodium vinyl sulphonate), 6.0E-3 pph of Mohrs salt, and 49.05 pph of water were charged to a pressure reactor and the reactor was heated to a polymerisation temperature of 65° C. 1.942 pph of vinyl acetate, 0.213 pph of lauryl acrylate and 1.25 pph of ethylene were now charged together with 0.106 pph of ammonium persulphate dissolved in 1.127 pph of water. Subsequent the so called pre-reaction, 36.4 pph of vinyl acetate and 4.0 pph of lauryl acrylate were continuously fed during 5 hours. A reactor pressure of 40 bar was, when charging of vinyl acetate commenced, applied by charging the ethylene monomer to the reactor. Said pressure was maintained until 3.56 pph of ethylene was charged and the ethylene charging was then stopped. The reactor was, following the continuous charging of the monomer mixtures, kept at 65° C. for a further hour. The prepared dispersion was now allowed to cool to room temperature.

The properties of the final dispersion and the polymerisation are given in Table 1.

### EXAMPLE 4

To a one liter glass reactor having an anchor stirrer were 16.03 parts per hundred of water and 4.11 parts per hundred of a dendritic polymer (Boltorn® H20, Perstorp Specialty Chemicals A D, Sweden) charged. The reactor was then heated to a polymerisation temperature of 82° C. In a separate vessel was a monomer emulsion prepared by charging 30.24 parts per hundred of water, 1.24 parts per hundred of a surfactant mixture (Disponil® A3065+Disponil® FES 77 IS, Cognis Deutschland GmbH1, Germany), 30.3 parts per hundred of methyl methacrylate, 0.64 parts per hundred of methacrylic acid and 10.1 parts per hundred of C₁₃-alkyl methacrylate. The monomer water mixture was stirred rigorously in order to create a stable monomer in water emulsion. To the reactor was 2.68 parts per hundred of the monomer emulsion charged together with 0.03 parts per hundred of ammonium persulphate dissolved in 0.43 parts per hundred of water. After the so called pre-reaction had ceased the remaining part of the monomer emulsion was continuously added to the reactor for 4.5 hours together with a solution of 0.18 parts per hundred of ammonium persulphate dissolved in 6.41 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.26 parts per hundred of water was added. The properties of the final dispersion and the polymerisation are given in Table 2.

### EXAMPLE 5

To a one liter glass reactor having an anchor stirrer were 16.54 parts per hundred of water and 1.06 parts per hundred of a dendritic polymer (Boltorn® H30, Perstorp Specialty Chemicals AB, Sweden) charged. The reactor was then heated to a polymerisation temperature of 82° C. In a separate vessel was a monomer emulsion prepared by charging 31.2 parts per hundred of water, 1.28 parts per hundred of a surfactant mixture (Disponil® A3065+Disponil® FES 77 IS, Cognis Deutschland GmbH, Germany), 14.59 parts per hundred of methyl methacrylate, 0.66 parts per hundred of methacrylic acid, 14.61 parts per hundred of butyl acrylate and 12.5 parts per hundred of C₁₇-alkyl methacrylate. The monomer water mixture was stirred rigorously in order to create a stable monomer in water emulsion. To the reactor was 2.77 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.61 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 6

To a one liter glass reactor having an anchor stirrer were 16.37 parts per hundred of water and 2.10 parts per hundred of a dendritic polymer (Boltorn® H30, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Disponil® A3065+Disponil® FES 77 IS, Cognis Deutschland GmbH, Germany), 20.62 parts per hundred of methyl methacrylate, 0.65 parts per hundred of methacrylic acid and 20.62 parts per hundred of C₁₃-alkyl methacrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.55 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 7

To a one liter glass reactor having an anchor stirrer were 16.37 parts per hundred of water and 2.10 parts per hundred of a dendritic polymer (Boltorn® H30, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Disponil® A3065+Disponil® FES 77 IS, Cognis Deutschland GmbH, Germany), 15.47 parts per hundred of methyl methacrylate, 0.65 parts per hundred of methacrylic acid, 15.47 parts per hundred of butyl acrylate and 10.31 parts per hundred of lauryl acrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.55 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 8

To a one liter glass reactor having an anchor stirrer were 16.37 parts per hundred of water and 2.10 parts per hundred of a dendritic polymer (Boltorn® H30, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Disponil® A3065+Disponil® FES 77 IS, Cognis Deutschland GmbH, Germany), 18.56 parts per hundred of methyl methacrylate, 0.65 parts per hundred of methacrylic acid and 4.12 parts per hundred of stearyl acrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.55 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 9

To a one liter glass reactor having an anchor stirrer were 16.37 parts per hundred of water and 2.10 parts per hundred of a dendritic polymer Boltorn® H30, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Disponil® A3065+Disponil® FES 77 IS, Cognis Deutschland GmbH, Germany), 15.47 parts per hundred of methyl methacrylate, 0.65 parts per hundred of methacrylic acid, 15.47 parts per hundred of ethyl hexyl acrylate and 10.31 parts per hundred of lauryl acrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.55 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 10

To a one litre glass reactor having an anchor stirrer were 16.69 parts per hundred of water and 2.14 parts per hundred of a dendritic polymer (Boltorn® H30, Perstorp Specialty Chemicals AB, Sweden) charged. The reactor was then heated to a polymerisation temperature of 82° C. In a separate vessel was a monomer emulsion prepared by charging 29.50 parts per hundred of water, 1.29 parts per hundred of a surfactant (Texapon® K12, Cognis Deutschland GmbH, Germany), 15.77 parts per hundred of methyl methacrylate, 0.67 parts per hundred of methacrylic acid, 15.77 parts per hundred of butyl acrylate and 10.52 parts per hundred of C₁₃-alkyl methacrylate. The monomer water mixture was stirred rigorously in order to create a stable monomer in water emulsion. To the reactor was 2.72 parts per hundred the monomer emulsion charged together with 0.03 parts per hundred of ammonium persulphate dissolved in 0.45 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.68 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 11

To a one litre glass reactor having an anchor stirrer were 16.37 parts per hundred of water and 2.10 parts per hundred of a dendritic polymer (Boltorn® H2003, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Disponil® A3065+Disponil® FES 77 IS, Cognis Deutschland GmbH, Germany), 15.47 parts per hundred of methyl methacrylate, 0.65 parts per hundred of methacrylic acid, 15.47 parts per hundred of butyl acrylate and 10.31 parts per hundred of C₁₃-alkyl methacrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.68 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 12

To a one litre glass reactor having an anchor stirrer were 16.70 parts per hundred of water and 0.43 parts per hundred of a dendritic polymer (Boltorn® EO3000, Perstorp Specialty Chemicals AB, Sweden) charged. The reactor was then heated to a polymerisation temperature of 82° C. In a separate vessel was a monomer emulsion prepared by charging 31.42 parts per hundred of water, 1.29 parts per hundred of a surfactant mixture (Disponil® A3065+Disponil® FES 77 IS, Cognis Deutschland GmbH, Germany), 21.04 parts per hundred of methyl methacrylate, 0.67 parts per hundred of methacrylic acid and 21.04 parts per hundred of C₁₃-alkyl methacrylate. The monomer water mixture was stirred rigorously in order to create a stable monomer in water emulsion. To the reactor was 2.79 parts per hundred the monomer emulsion charged together with 0.03 parts per hundred of ammonium persulphate dissolved in 0.45 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.68 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 13

To a one litre glass reactor having an anchor stirrer were 16.58 parts per hundred of water and 0.85 parts per hundred of a dendritic polymer (Boltorn® EO3000, Perstorp Specialty Chemicals AB, Sweden) charged. The reactor was then heated to a polymerisation temperature of 82° C. In a separate vessel was a monomer emulsion prepared by charging 31.27 parts per hundred of water, 1.29 parts per hundred of a surfactant mixture (Disponil® A3065+Disponil® FBS 77 IS, Cognis Deutschland GmbH, Germany), 20.89 parts per hundred of methyl methacrylate, 0.66 parts per hundred of methacrylic acid and 20.89 parts per hundred of C₁₃-alkyl methacrylate. The monomer water mixture was stirred rigorously in order to create a stable monomer in water emulsion. To the reactor was 2.77 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.63 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 14

To a one litre glass reactor having an anchor stirrer were 16.08 parts per hundred of water and 1.24 parts per hundred of a dendritic polymer (Boltorn® EO3000, Perstorp Specialty Chemicals AB, Sweden) charged. The reactor was then heated to a polymerisation temperature of 82° C. In a separate vessel was a monomer emulsion prepared by charging 31.34 parts per hundred of water, 1.24 parts per hundred of a surfactant mixture (Disponil® A3065+Disponil® FES 77 IS, Cognis Deutschland GmbH, Germany), 20.26 parts per hundred of methyl methacrylate, 0.64 parts per hundred of methacrylic acid and 20.26 parts per hundred of C₁₃-alkyl methacrylate. The monomer water mixture was stirred rigorously in order to create a stable monomer in water emulsion. To the reactor was 2.73 parts per hundred the monomer emulsion charged together with 0.03 parts per hundred of ammonium persulphate dissolved in 0.43 parts per hundred of water. After the so called pre-reaction had ceased the remaining part of the monomer emulsion was continuously added to the reactor for 4.5 hours together with a solution of 0.18 parts per hundred of ammonium persunphate dissolved in 6.43 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.26 parts per hundred of water was added.

The properties of the final dispersion and the polymerisation are given in Table 2.

### EXAMPLE 15

To a one litre glass reactor having an anchor stirrer were 16.37 parts per hundred of water and 2.10 parts per hundred of a dendritic polymer (Boltorn® EO3000, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Disponil® A3065+Disponil® FES 77 IS, Cognis Deutschland GmbH, Germany), 20.62 parts per hundred of methyl methacrylate, 0.65 parts per hundred of methacrylic acid and 20.62 parts per hundred of C₁₃-alkyl methacrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.55 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 16

To a one litre glass reactor having an anchor stirrer were 16.03 parts per hundred of water and 4.11 parts per hundred of a dendritic polymer (Boltorn® EO3000, Perstorp Specialty Chemicals AB, Sweden) charged. The reactor was then heated to a polymerisation temperature of 82° C. In a separate vessel was a monomer emulsion prepared by charging 30.24 parts per hundred of water, 1.24 parts per hundred of a surfactant mixture (Disponil® A3065+Disponil® FES 77 IS, Cognis Deutschland GmbH, Germany), 20.20 parts per hundred of methyl methacrylate, 0.64 parts per hundred of methacrylic acid and 20.20 parts per hundred of C₁₃-alkyl methacrylate. The monomer water mixture was stirred rigorously in order to create a stable monomer in water emulsion. To the reactor was 2.68 parts per hundred the monomer emulsion charged together with 0.03 parts per hundred of ammonium persulphate dissolved in 0.43 parts per hundred of water. After the so called pre-reaction had ceased the remaining part of the monomer emulsion was continuously added to the reactor for 4.5 hours together with a solution of 0.18 parts per hundred of ammonium persulphate dissolved in 6.41 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.26 parts per hundred of water was added.

The properties of the final dispersion and the polymerisation are given in Table 2.

### EXAMPLE 17

To a one litre glass reactor having an anchor stirrer were 16.37 parts per hundred of water and 2.10 parts per hundred of a dendritic polymer (Boltorn® EO3000, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Dispoil® A3065+Disponil® FES 77 IS, Cognis Deutschland GmbH, Germany), 15.47 parts per hundred of methyl methacrylate, 0.65 parts per hundred of methacrylic acid, 15.47 parts per hundred of butyl acrylate and 10.31 parts per hundred of C₁₃-alkyl methacrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.55 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 18

To a one litre glass reactor having an anchor stirrer were 16.69 parts per hundred of water and 2.14 parts per hundred of a dendritic polymer (Boltorn® EO3000, Perstorp Specialty Chemicals AB, Sweden) charged. The reactor was then heated to a polymerisation temperature of 82° C. In a separate vessel was a monomer emulsion prepared by charging 29.50 parts per hundred of water, 1.29 parts per hundred of a surfactant (Texapon® K12, Cognis Deutschland GmbH, Germany), 15.77 parts per hundred of methyl methacrylate, 0.67 parts per hundred of methacrylic acid, 15.77 parts per hundred of butyl acrylate and 29.50 parts per hundred of C₁₃-alkyl methacrylate. The monomer water mixture was stirred rigorously in order to create a stable monomer in water emulsion. To the reactor was 2.72 parts per hundred the monomer emulsion charged together with 0.03 parts per hundred of ammonium persulphate dissolved in 0.45 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.68 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 19

To a one litre glass reactor having an anchor stirrer were 16.55 parts per hundred of water and 2.12 parts per hundred of a dendritic polymer (Boltorn® EO3000, Perstorp Specialty Chemicals AB, Sweden) charged. The reactor was then heated to a polymerisation temperature of 82° C. In a separate vessel was a monomer emulsion prepared by charging 30.10 parts per hundred of water, 1.28 parts per hundred of a surfactant (Triton™ XN45S, The Dow Chemical Company, USA), 15.64 parts per hundred of methyl methacrylate, 0.66 parts per hundred of methacrylic acid, 15.64 parts per hundred of butyl acrylate and 10.43 parts per hundred of C₁₃-alkyl methacrylate. The monomer water mixture was stirred rigorously in order to create a stable monomer in water emulsion. To the reactor was 2.73 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.62 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 20

To a one litre glass reactor having an anchor stirrer were 15.91 parts per hundred of water and 0.85 parts per hundred of a dendritic polymer (Boltorn® EO3000, Perstoip Specialty Chemicals AB, Sweden) charged. The reactor was then heated to a polymerisation temperature of 82° C. In a separate vessel was a monomer emulsion prepared by charging 32.46 parts per hundred of water, 1.01 parts per hundred of a surfactant (Emulsogen® EPA073, Clariant GmbH, Germany), 36.42 parts per hundred of methyl methacrylate, 0.68 parts per hundred of methacrylic acid, 4.05 parts per hundred of stearyl acrylate and 0.85 parts per hundred of the dendritic polymer type 4. The monomer water mixture was stirred rigorously in order to create a stable monomer in water emulsion. To the reactor was 2.79 parts per hundred the monomer emulsion charged together with 0.03 parts per hundred of ammonium persulphate dissolved in 0.46 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.76 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 21

To a one litre glass reactor having an anchor stirrer were 16.37 parts per hundred of water and 2.10 parts per hundred of a dendritic polymer (Boltorn® H310, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Disponil® A3065+Disponil® FES 77 IS, Cognis Deutschland GmbH, Germany), 20.62 parts per hundred of methyl methacrylate, 0.65 parts per hundred of methacrylic acid and 20.62 parts per hundred of C₁₃-alkyl methacrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.55 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 22

To a one litre glass reactor having an anchor stirrer were 16.37 parts per hundred of water and 2.10 parts per hundred of a dendritic polymer (Boltorn® H310, Perstorp Specialty Chemicals AB, Sweden) charged. The reactor was then heated to a polymerisation temperature of 82° C. In a separate vessel was a monomer emulsion prepared by charging 30.88 parts per hundred of water, 1.27 parts per hundred of a surfactant mixture (Disponil® A3065+Disponil® FES 77 IS, Cognis Deutschland GmbH, Germany), 15.47 parts per hundred of methyl methacrylate, 0.65 parts per hundred of methacrylic acid, 15.47 parts per hundred of butyl acrylate and 10.31 parts per hundred of C₁₃-alkyl methacrylate. The monomer water mixture was stirred rigorously in order to create a stable monomer in water emulsion. To the reactor was 2.74 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammuonium persulphate dissolved in 6.55 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 23

To a one litre glass reactor having an anchor stirrer were 15.67 parts per hundred of water, 0.05 parts per hundred of a surfactant mixture and 3.19 parts per hundred of a dendritic polymer (Boltorn® H310, Perstorp Specialty Chemicals AB, Sweden) charged. The reactor was then heated to a polymerisation temperature of 82° C. In a separate vessel was a monomer emulsion prepared by charging 31.97 parts per hundred of water, 0.99 parts per hundred of a surfactant (Emulsogen® EPA073, Clariant GmbH, Germany), 35.86 parts per hundred of methyl methacrylate, 0.67 parts per hundred of methacrylic acid and 3.98 parts per hundred of C₁₃-alkyl methacrylate. The monomer water mixture was stirred rigorously in order to create a stable monomer in water emulsion. To the reactor was 2.72 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.66 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 24

To a one litre glass reactor having an anchor stirrer were 15.61 parts per hundred of water, 0.05 parts per hundred of a surfactant mixture and 1.78 parts per hundred of a dendritic polymer (Boltorn ® H310, Perstorp Specialty Chemicals AB, Sweden) charged. The reactor was then heated to a polymerisation temperature of 82° C. In a separate vessel was a monomer emulsion prepared by charging 31.85 parts per hundred of water, 0.99 parts per hundred of a surfactant (Emulsogen® EPA073, Clariant GmbH, Germany), 35.72 parts per hundred of methyl methacrylate, 0.66 parts per hundred of methacrylic acid, 1.78 parts per hundred of the dendritic polymer type 5 and 3.97 parts per hundred of C₁₃-alkyl methacrylate. The monomer water mixture was stirred rigorously in order to create a stable monomer in water emulsion. To the reactor was 2.77 parts per hundred the monomer emulsion charged together with 0.03 parts per hundred of ammonium persulphate dissolved in 0.44 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.63 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 25

To a one litre glass reactor having an anchor stirrer were 16.69 parts per hundred of water and 2.14 parts per hundred of a dendritic polymer (Boltornφ H310, Perstorp Specialty Chemicals AB, Sweden) charged. The reactor was then heated to a polymerisation temperature of 82° C. In a separate vessel was a monomer emulsion prepared by charging 29.50 parts per hundred of water, 1.29 parts per hundred of a surfactant (Texapon® K12, Cognis Deutschland GmbH, Germany), 15.77 parts per hundred of methyl methacrylate, 0.67 parts per hundred of methacrylic acid, 15.77 parts per hundred of butyl acrylate and 10.52 parts per hundred of C₁₃-alkyl methacrylate. The monomer water mixture was stirred rigorously in order to create a stable monomer in water emulsion. To the reactor was 2.72 parts per hundred the monomer emulsion charged together with 0.03 parts per hundred of ammonium persulphate dissolved in 0.45 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.68 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammnonia mixed with 0.27 parts per hundred of water was added.

The properties of the final dispersion and the polymerisation are given in Table 2.

### EXAMPLE 26

### Reference

To a one litre glass reactor having an anchor stirrer was 16.72 parts per hundred of water charged. The reactor was then heated to a polymerisation temperature of 82° C. In a separate vessel was a monomer emulsion prepared by charging 31.54 parts per hundred of water, 1.29 parts per hundred of a surfactant mixture (Disponil® A3065+Disponil® FES 77 IS, Cognis Deutschland GmbH, Germany), 29.49 parts per hundred of methyl methacrylate, 0.67 parts per hundred of methacrylic acid and 12.64 parts per hundred of stearyl methacrylate. The monomer water mixture was stirred rigorously in order to create a stable monomer in water emulsion. To the reactor was 2.80 parts per hundred the monomer emulsion charged together with 0.03 parts per hundred of ammonium persulphate dissolved in 0.45 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.69 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 27

### Reference

To a one litre glass reactor having an anchor stirrer was 16.72 parts per hundred of water charged. The reactor was then heated to a polymerisation temperature of 82° C. In a separate vessel was a monomer emulsion prepared by charging 31.54 parts per hundred of water, 1.29 parts per hundred of a surfactant mixture (Disponil® A3065+Disponil® FES 77 IS, Cognis Deutschland GmbH, Germany), 21.06 parts per hundred of methyl methacrylate, 0.67 parts per hundred of methacrylic acid and 21.06 parts per hundred of C₁₃-alkyl methacrylate. The monomer water mixture was stirred rigorously in order to create a stable monomer in water emulsion. To the reactor was 2.80 parts per hundred the monomer emulsion charged together with 0.03 parts per hundred of ammonium persulphate dissolved in 0.45 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.69 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

### EXAMPLE 28

### Reference

To a one litre glass reactor having an anchor stirrer was 16.72 parts per hundred of water charged. The reactor was then heated to a polymerisation temperature of 82° C. In a separate vessel was a monomer emulsion prepared by charging 31.54 parts per hundred of water, 1.29 parts per hundred of a surfactant mixture (Disponil® A3065+Disponil® BES 77 IS, Cognis Deutschland GmbH, Germany), 18.96 parts per hundred of methyl methacrylate, 0.67 parts per hundred of methacrylic acid 18.96 parts per hundred of butyl acrylate and 4.21 parts per hundred of stearyl methacrylate. The monomer water mixture was stirred rigorously in order to create a stable monomer in water emulsion. To the reactor was 2.80 parts per hundred the monomer emulsion charged together with 0.03 parts per hundred of ammonium persulphate dissolved in 0.45 parts per hundred of water. After the so called pre-reaction had ceased the remaining part of the monomer emulsion was continuously added to the reactor for 4.5 hours together with a solution of 0.19 parts per hundred of ammonium persulphate dissolved in 6.69 parts per hundred of water. After the continuous adding of the monomer emulsion and the ammonium persulphate solution was ended the reactor was kept at 82° C. for one more hour. The prepared dispersion was then allowed to cool to room temperature and a solution of a 0.03 parts per hundred of a 25% ammonia mixed with 0.27 parts per hundred of water was added.

The properties of the final dispersion and the polymerisation are given in Table 2.

TABLE 1
Properties of dispersions and polymerisations of Examples 1-3.

| | Solids | Tg | | Viscosity | Particle | Grit | MD | RHBM |
|---|---|---|---|---|---|---|---|---|
| Example | content % | ° C. | pH | Pas | size nm | %-w/w | %-vol | %-w/w |
| 1 | 48.3 | 1 | 4.4 | 0.6 | 0.13 | 0.01 | 0 | 100 |
| 2 | 49.1 | 5 | 5.1 | 0.5 | 0.13 | 0.1 | 0 | 100 |
| 3 | 52 | 4 | 4.5 | 0.6 | 0.13 | 5.8 | 8 | 0 |
| Ref. | | | | | | | | |

%-w/w = Percent by weight.
%-vol = Percent by volume.
Tg = Glass transition temperature.
Grit as weight percent is calculated from the total monomer.
MD = percent monomer droplets calculated from the integrated total volume distribution of particles sizes obtained by a laser light diffraction instrument.
RHBM = Percent reacted hydrophobic monomer.

TABLE 2
Properties of dispersions and polymerisations of Examples 4-28.

| | Solids | Tg | | Viscosity | Particle | Grit | MD | RHBM |
|---|---|---|---|---|---|---|---|---|
| Example | Content % | ° C. | pH | Pas | size nm | g | %-vol | %-w/w |
| 4 | 44.5 | 63 | 3.7 | 0.018 | 0.12 | 61 | 0 | 100 |
| 5 | 50.0 | n.a. | 3.4 | 0.020 | 0.22 | 9 | 5 | 85 |
| 6 | 42.7 | 46 | 1.9 | 0.485 | 0.18 | 4 | 10 | 80 |
| 7 | 44.8 | 29 | n.a. | n.a. | 0.13 | >1 | 6 | 76 |
| 8 | 43.4 | 12 | n.a. | n.a. | 0.13 | >1 | 3 | 88 |
| 9 | — | n.a. | n.a. | n.a. | 0.13 | >1 | 3 | 88 |
| 10 | 44.9 | 43 | n.a. | n.a. | 0.17 | >1 | 0 | 100 |
| 11 | 42.9 | 41 | 2.0 | 0.018 | 0.13 | >1 | 9 | 65 |
| 12 | 40.5 | 2.5 | 6.4 | 0.012 | 0.12 | n.a. | 10 | 80 |
| 13 | 43.0 | 32 | 5.7 | 0.006 | 0.14 | 8 | 8 | 84 |
| 14 | 43.3 | 17 | 7.1 | 0.014 | 0.14 | n.a. | 3 | 94 |
| 15 | 44.5 | 31 | 5.1 | 0.008 | 0.42 | 14 | 0 | 100 |
| 16 | n.a. | 44 | n.a. | n.a. | 0.53 | 60 | 10 | 80 |
| 17 | 43.8 | 30 | 2.0 | 0.018 | 0.28 | 6 | 15 | 60 |
| 18 | 44.0 | 43 | 1.9 | 0.020 | 0.30 | >1 | 10 | 60 |
| 19 | 44.3 | 39 | 2.0 | 0.022 | 0.24 | >1 | 10 | 61 |
| 20 | 42.9 | 3 | 7.7 | 0.007 | 0.14 | n.a. | 3 | 68 |
| 21 | 42.0 | 55 | 2.0 | n.a. | 0.11 | 30 | 20 | 60 |
| 22 | 41.7 | 32 | 2.0 | 0.021 | 0.12 | 16 | 10 | 60 |
| 23 | 41.7 | 89 | 3.1 | 0.018 | 0.12 | >1 | 0 | 100 |
| 24 | 42.5 | 17 | 3.1 | 0.030 | 0.11 | >1 | 0 | 100 |
| 25 | 44.2 | n.a. | 1.9 | 0.006 | 0.11 | 2 | 8 | 68 |
| 26 Ref. | n.a. | n.a. | n.a. | n.a. | 0.11 | 70 | 45 | 0 |
| 27 Ref. | n.a. | n.a. | n.a. | n.a. | 0.11 | 50 | 40 | 20 |
| 28 Ref. | n.a. | 16 | n.a. | n.a. | 0.11 | 16 | 10 | 0 |

%-w/w = Percent by weight.
%-vol = Percent by volume.
n.a. = Not applicable.
Tg = Glass transition temperature.
Grit weight percent is calculated from the total monomer.
MD = percent monomer droplets calculated from the integrated total volume distribution of
particles sizes obtained by a laser light diffraction instrument.
RHBM = Percent reacted hydrophobic monomer.

1. A method for production of a waterborne copolymer dispersion wherein that yielded copolymer comprises monomer units derived from at least one polymerisable hydrophobic allyl, vinyl, maleic or diene monomer having a water solubility of less than 0.001 g/l and wherein said copolymer dispersion is obtained in an emulsion polymerisation performed in an aqueous media and in presence of 0.05-99.5% by weight, calculated on total amount of polymerisable monomers, of at least one dendritic polymer.

2. A method according to claim 1, wherein that said emulsion polymerisation is a one or multi stage emulsion polymerisation.

3. A method according to claim 1 wherein that said emulsion polymerisation is performed at atmospheric pressure using liquid monomers.

4. A method according to claim 1 wherein that said emulsion polymerisation is a pressure polymerisation performed at a pressure of 1-200 bar, using at least one gaseous monomer.

5. A method according to claim 1, wherein said dendritic polymer is a hydroxyfunctional dendritic polyester, polyether, polyesteramide or polyetheramide.

6. A method according to claim 5 wherein said dendritic polymer is built up from a monomeric or polymeric core molecule having at least one reactive hydroxyl or epoxide group and at least one branching chain extender having at least two hydroxyl groups and at least one carboxyl group.

7. A method according to claim 5 where said dendritic polymer is built up from a monomeric or polymeric core molecule having at least one reactive hydroxyl or epoxide group and at least one branching chain extender having at least one hydroxyl group and at least one oxetane group.

8. A method according to claim 6 , wherein said dendritic polymer has at least two dendritic generations.

9. A method according to claim 6, wherein said dendritic polymer is further chain extended by addition of at least one alkylene oxide, at a molar ratio of hydroxyl groups to alkylene oxide of at least 1:40.

10. A method according to claim 6, wherein said dendritic polymer is further chain extended by addition of at least one chain extender having one hydroxyl group and one carboxyl group.

11. A method according to claim 6, wherein said dendritic polymer is partially chain terminated by addition of at least one chain stopper.

12. A method according to claim 1, wherein said at least one polymerisable hydrophobic monomer is at least one C₁₁-C₂₈alkyl acrylate methacrylate or crotonate.

13. A method according to claim 1, wherein said copolymer additionally comprises monomer units derived from at least one C₁-C₁₀ alkyl acrylate, methacrylate or crotonate.

14. A method according to claim 1, wherein said copolymer additionally comprises monomer units derived from acrylic acid, methacrylic acids crotonic acid, isocrotonic acid, itaconic acid, maleic anhydride and/or fumaric acid.

15. A method according to claim 1, wherein said copolymer additionally comprises monomer units derived from at least one glycidyl acrylate, glycidyl methacrylate and/or allyl methacrylate.

16. A method according to that claim 1, wherein said copolymer additionally comprises monomer units derived from ethylene and/or propylene.

17. A method according to claim 1, wherein said copolymer additionally comprises monomer units derived from styrene and/or divinylstyrene.

18. A method according to claim 1, wherein said copolymer additionally comprises monomer units derived from vinyl acetate, vinyl propionate, vinyl versatate and/or dibutyl maleate.

19. A method according to any of the claims 1-12 that claim 1, wherein said copolymer additionally comprises monomer units derived from butadiene and/or isoprene.

20. A method according to claim 1, wherein said copolymer additionally comprises monomer units derived from acryl amide. N-methylolacrylamide, N-methylolmethacrylamide, N-(iso-butoxymethyl)acrylamide, N-(n-butoxymethyl)acrylamide and/or imidazolidine methacrylate.

21. A method according to claim 1, wherein said copolymer additionally comprises monomer units derived from at least one di, tri or multifunctional ester of a di, tri or polyhydric alcohol and acrylic and/or methacrylic acid.

22. A method according to claim 1, wherein said copolymer additionally comprises monomer units derived from at least one trialkoxyvinylsilane, alkyldialkoxy-vinylsilane, acryloxyalkoxysilane, acryloxyalkylalkoxysilane, alkoxyacrylsilane, methacryloxyalkoxysilane, methacryloxyalkylalkoxysilane and/or alkoxymethacrylsilane.

23. A method according to claim 1, wherein at least one chain transfer agent is present is present during polymerisation of at least one said monomer.

24. A method according to claim 1, wherein said copolymer dispersion comprises at least one polymerisable surfactant and/or a conventional surfactant.

25. A coating composition comprising as a binder a waterborne copolymer dispersion obtained by the method of claim 1.
